(19) United States
(12) Patent Application Publication
(10) Pub. No.: US 2019/0238338 A1
(43) Pub. Date: Aug. 1, 2019

(54) CLONING DRONES USING BLOCKCHAIN

(71) Applicant: Walmart Apollo, LLC, Bentonville, AR (US)

(72) Inventors: John J. O'BRIEN, Farmington, AR (US); Donald R. HIGH, Noel, MO (US); Joseph JURICH, Molino, FL (US); Brian MCHALE, Oldham (GB); Robert CANTRELL, Herndon, VA (US); Todd MATTINGLY, Bentonville, AR (US)

(73) Assignee: Walmart Apollo, LLC, Bentonville, AR (US)

(21) Appl. No.: 16/262,494

(22) Filed: Jan. 30, 2019

Related U.S. Application Data
(60) Provisional application No. 62/624,720, filed on Jan. 31, 2018.

(51) Int. Cl. H04L 9/32; H04L 9/06; B64C 39/02; G08G 5/00; H04W 4/40; H04L 29/06

(52) U.S. Cl. CPC H04L 9/3242; H04L 9/0637; B64C 39/024; H04L 2209/38; H04W 4/40; H04L 63/062; G08G 5/0008

(57) ABSTRACT

A method of drone-drone communications using blockchain includes: determining operational parameters of a first drone; encrypting the operational parameters of the first drone; storing the encrypted operational parameters of the first drone in a block of a blockchain; determining when a second drone is in proximity of the first drone; retrieving the encrypted operational parameters of the first drone from the block of the blockchain; decrypting the encrypted operational parameters of the first drone; retrieving the operational parameters of the first drone based on the decryption; and configuring the second drone with the operational parameters of the first drone.

### BACKGROUND

### 1. Technical Field

The present disclosure relates to communication technology, and more specifically to a system and method for vehicle to vehicle communications.

### 2. Introduction

As unmanned vehicles, such as drones, continue to evolve, communications between them continue to evolve. For example, unmanned vehicles may be designed to use mesh networks for communications between them, such that every vehicle is aware of the speed, direction, braking, etc., of the other vehicles, allowing unprecedented coordination. Further, messages may be relayed from vehicle to vehicle.

However, while the currently available communications between devices or vehicles allow for more informed devices, they do not necessarily improve other aspects of the devices. For example, having more informed devices does not, by itself, provide for collaborative computing, nor collaboratively storing data in databases.

### SUMMARY

A method of vehicle-vehicle communications using blockchain includes: determining operational parameters of a first vehicle; encrypting the operational parameters of the first vehicle; storing the encrypted operational parameters of the first vehicle in a block of a blockchain; determining when a second vehicle is in proximity of the first vehicle; retrieving the encrypted operational parameters of the first drone from the block of the blockchain; decrypting the encrypted operational parameters of the first drone; retrieving the operational parameters of the first drone based on the decryption; and configuring the second vehicle with the operational parameters of the first vehicle.

A blockchain-based system of vehicle-vehicle communications includes a plurality of vehicles configured to: receive an encrypted message by an initial vehicle of the plurality of vehicles, wherein the encrypted message is addressed to a destination vehicle of the plurality of vehicles and encrypted by an unique identifier of the destination vehicle; store the encrypted message in a first block of a blockchain; update the received encrypted message to include an unique identifier of the initial vehicle; store the updated message in a second block of the blockchain; relay the updated message to one or more intermediary vehicles of the plurality of vehicles, wherein the one or more intermediary vehicles are located between the initial vehicle and the destination vehicle, the one or more intermediary vehicles further update the updated message to include their corresponding unique identifiers, the further updated message is stored in a corresponding block of the block chain, the one or more intermediary vehicles relay the further updated message to the destination vehicle; and retrieve, by the destination vehicle, the encrypted message from the further updated message.

A blockchain-based method for vehicle-vehicle communications includes: receiving an encrypted message by an initial vehicle of a plurality of vehicles, wherein the encrypted message is addressed to a destination vehicle of the plurality of vehicles and encrypted by an unique identifier of the destination vehicle; storing the encrypted message in a first block of a blockchain; updating the received encrypted message to include an unique identifier of the initial vehicle; storing the updated message in a second block of the blockchain; relaying the updated message to one or more intermediary vehicles of the plurality of vehicles, wherein the one or more intermediary vehicles are located between the initial vehicle and the destination vehicle, the one or more intermediary vehicles further update the updated message to include their corresponding unique identifiers, the further updated message is stored in a corresponding block of the block chain, the one or more intermediary vehicles relay the further updated message to the destination vehicle; and retrieving the encrypted message from the further updated message.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

FIG. 1 illustrates an exemplary mesh network between unmanned vehicles/devices;

FIG. 2 illustrates an exemplary blockchain based on interactions between devices;

FIG. 3 illustrates an exemplary method of communications between devices; and

FIG. 4 illustrates an exemplary computer system.

### DETAILED DESCRIPTION

Various configurations and embodiments of the disclosure are described in detail below. While specific implementations are described, it should be understood that this is done for illustration purposes only. Other components and configurations may be used without parting from the spirit and scope of the disclosure.

Systems, methods, and computer-readable storage media configured according to this disclosure are capable of distributing and relaying messages and database information resources among two or more devices. Transmissions and messages may be encrypted by a drone's unique identifier. If the drone's signal is repeated/relayed by another drone, both the drone repeating the signal as well as the drone first sending the signal, may be included in an updated signal. This may ensure the safety of drones.

In some embodiments, the disclosed system may allow for communications between parties while maintaining anonymity. The system may be applied for communications with drones which may be out of range of a central controller. The central controller may communicate with another drone which is in range. The other drone may relay the message to the intended drone, which is out of range of the central controller, but in range of the other drone. The system may send an unencrypted message with an encrypted one intended for a destination drone. The relaying drone or drones may receive the message and relay it along until it arrives at the destination drone. The relaying drones may also append their information to a blockchain (e.g., date and time, drone serial number, drone location, etc.). The destination drone may have the key to unlock the encrypted message.

In some embodiments, the system may allow for a message to be re-routed dynamically as it passes from drone to drone, and as drones move out of and into communication range with the central controller and each other. The system may also alter the path or speed of an intermediary drone to allow it to relay a message. The messages may be re-routed at each hop based upon signal strength, message priority, available drones, etc. The central controller may instruct a drone not to forward a message if the message becomes redundant.

In some embodiments, the message may be sent along with a hash of the message, which may be compared with the hash derived from the received message by the destination drone. If the two hashes match, the message may be considered authentic.

In some embodiments, the system may use blockchain data to audit communications (e.g. average number of hops from drone A to drone B; latency from drone A to drone B; etc.). The system may also identify close-by vehicles, which may be used for reverse communications back to the central controller. Third party drones may relay communications and after successfully relaying communications, may earn trust from the system (e.g., may be assigned a confidence level).

In some embodiments, the system may also be used for passing unencrypted messages to all drones in an area (such as weather or safety concerns). The drones may each receive the message, compare the hash and then relay the message along.

In some embodiments, drones may fly in areas affected by a natural or man-made disaster. These drones may act as temporary cell or other communication towers for a disaster area. The various flying towers (drones) may communicate among themselves using blockchain for encryption and verification. The system may also provide unused drone communications capacity to customers in the area. The system may further act as a wireless data provider on a limited basis. This may work for Internet of Things (IoT) devices to communicate with the outside world. The IoT system may store its data until a drone is in the area and then send a burst communication to the outside world.

In some embodiments, the drones may employ local WIFI signals to relay messages with a central controller. The system may identify those public or private WIFI hubs which have agreed to act as message transfer facilities.

In some embodiments, drones may be cloned. For example, operational parameters of a successful drone may be cloned onto a drone(s) that is close in proximity to the successful drone. In such a way, consistent operational parameters of a plurality of drones may be ensured. The cloning may be employed by cloning the software profile of drone, such that it may be completely identical from drone to drone. This may also cover sensorial computer to drone communication, for example, mission information or delivery details, provided in a blockchain. This way, if the first drone is unable to make the delivery, that same information may be relayed by the blockchain to an alternate drone.

The advantages of using blockchain may include providing integrity of the information being delivered. A blockchain ledger may store any kind of information that may be stored in any other format or medium, for example, a large list of instructions of different types, navigational information, and maps. In such a way, a same software profile may be deployed across the cloned drones.

In some embodiments, the drone system may be configured to only allow certain types of c information to be transmitted through a blockchain. Critical information, for example, highly sensitive information (e.g., order detail) is allowed to be stored in a blockchain, to assure that the critical information is not tampered with. Provisioning authentication and authorization credentials may also be allowed to be saved in the blockchain. Further, each drone may have a unique transponder identifier that may be provisioned through the blockchain.

In some embodiment, sensors themselves may have their own, private key, and then communicate with the drone system, so the drone may then communicate information to another drone.

In some embodiments, as a device (e.g., a central controller) determines that it needs to send information to a destination device (a drone). The device sends a request to other devices (drones) requesting that those other devices relay the information to the destination device that is out of range of the central controller. This distribution request can, for example, be broadcast through a mesh network between devices, until all the devices within a group, or within a radius (a range) of the initial requesting device, have received the request. As devices receive the request, responses to the request are generated and sent back to the requesting device, each response providing an answer as to the ability of each respective device to fulfill the request. The requesting device receives the responses, aggregates and/or analyzes the responses, and determines how to relay the message. In some cases, this can require transferring information from the requesting device to another device through the mesh network. In addition, this can require modifying computing capacities or configurations at the requesting device as well as other devices within the group of devices. These changes would be broadcast to the group through the mesh network, with any computing resource transitions likewise similarly being broadcast to the group.

Each of these devices may be capable of being remotely controlled and configured by a user through a WiFi or other wireless connection. In addition, the devices within this group can communicate with one another. In some configurations, such communications can utilize a mesh network (i.e., each device communicates with the other devices directly using RF, low power, Bluetooth, or other wireless short range communication mechanisms, or if direct communication is not possible due to power or range restriction, indirectly through communication relays provided by another device in the group), whereas in other configurations the communications occur directly through the wireless network.

In some configurations, communications between the devices can take the form of a blockchain, where each request and response made by devices can be added to the blockchain ledger. As any device takes an action (sending a request, sending a response to a request), that information is added to the blockchain. More specifically, the request, response, or other action is hashed into the previous blockchain. This new, updated blockchain is then distributed to the other devices within the group.

The devices may be unmanned or autonomous vehicles, drones, robotics, communication devices, or any other electronic device. For example, in one configuration the devices may be delivery drones, whereas in another configuration the devices may be autonomous vehicles or smart home devices. In yet another configuration, the devices may be distinct types of devices, such as a drone and smart home devices communicating, making requests, and generating responses to those requests.

By implementing the requests and responses, the devices within a group can determine which devices are unused, under-utilized, or in use, and may allow the entire group of devices to share the information in a partitioned or redundant manner. In other words, devices in the group can collaborate using distributed intelligence as it relates to their respective memories, and can make decisions on sharing the information based on that information distribution. To do this, each device may have a predictive element as part of its operations, whereby each of the devices understands its own peaks and troughs of performance, and can be ready to share their database capacity (both to store and/or share information) based on that understanding. This can help with registry and shared repository information of devices within the network, failing devices, backup and recovery of information, etc. For example, the group of devices may share a registry redundantly among themselves or on the cloud which would also provide a method of failover from one device to another, or from the cloud.

The information shared between devices (i.e., on the mesh network) can do so in a peer-peer network of devices that is decentralized. That is, all devices have the potential for storing, sharing, and otherwise distributing/relaying information needed by any device. This system can be authenticated, shared, and managed, by a blockchain system for authentication and decentralization. A device can relay an initial blockchain of information, as a request, to all other devices in the group. Other devices within the group will receive and authenticate the transmission, then provide information the first device needs to solve the request. This in turn causes an update to the previous block within the blockchain, which will contain the “slave” (second) device's updates with the original “master” initial block (the request). Thus, the necessary information will be accurately shared between the devices, including updates, etc.

By sharing the data and information between devices, replacement devices may be swapped and retain the history from the prior devices once the devices make the association. An association can be made either by manufacture's data from a web site using an API call, or by a user making the association. For example, a broken device may be replaced by a replacement device and the replacement device would gather the broken device's data from the network once it is registered into the network. All the data associated with the broken device would now carry over to the replacement device. Data could be when the devices were used, how many hours in service, and what messages have been shared/relayed.

The information shared and transmitted between devices (such as requests for assistance, responding to requests for assistance, authentication, and protocol sharing), and the additional information being requested by a device, can utilize blockchain or other authentication methods. Exemplary data which can be stored on a device (and transmitted/received between devices as required) can include a history log, a usage of the device, consumption of power (or other measurement of use), maintenance performed, downtime, consumption of products or other received elements, and/or schedule for future usage.

The information can require moving data, updating or changing processors, modifying memory, flying to a desired location, delivering a package, lowering flying height, reducing flying speed, or other similar tasks. In one example, a device is scheduled to perform a task but determines it would be faster if additional information could be provided. One way the device can do this is by planning a shared task configuration, where the first device and another device are configured in a planned manner which enables information sharing, then sending the shared task configuration to other devices to determine availability. If another device can assist, the initiating device could send out a signal to the other device to alter its configuration (i.e., processor or memory) to share the information as instructed by the initiating device. Simultaneously, the initiating device can modify its configuration according to the planned shared task configuration.

Another way the device can share the task is to send a request to other devices inquiring about the availability of the other devices to provide the needed information. Upon receiving the responses to the request, the initiating device can aggregate and analyze the responses, then determine based on the aggregated/analyzed data how to divide the task. This determination would result in a planned shared task configuration, which could be sent to the other devices in the group. The initiating device and the other devices could then modify their respective configurations to match the planned shared task configuration and perform the task of sharing database information.

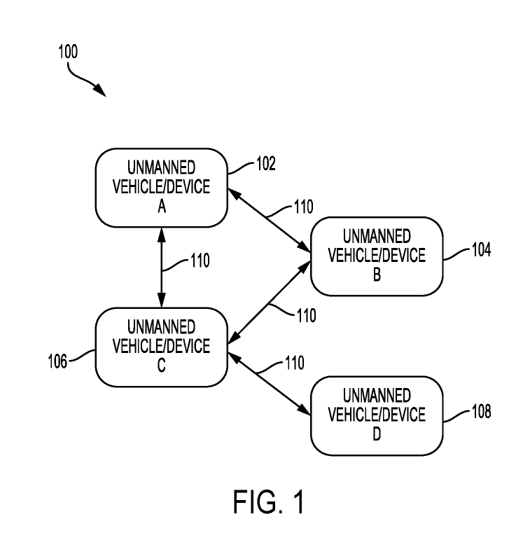

Various specific embodiments of the disclosure are described in detail below. While specific implementations are described, it should be understood that this is done for illustration purposes only. Other components and configurations may be used without parting from the spirit and scope of the disclosure, and can be implemented in combinations of the variations provided. These variations shall be described herein as the various embodiments are set forth. The disclosure now turns to FIG. 1.

FIG. 1 illustrates an exemplary mesh network 100 between unmanned vehicles/devices 102, 104, 106, 108. A mesh network such as that illustrated is a network where each node can relay data from and to other nodes within the network. While mesh networks can be constructed to operate in wired conditions, they are more prevalent in wireless configurations, where messages can be broadcast/flooded to other nearby nodes (i.e., not sent to a specific node, but rather all nodes within a given distance of the broadcasting node). When a receiving node is located outside the broadcast range of a transmitting node, intermediate nodes may be required to route the transmission to the receiving node. For example, as illustrated, node A 102 can communicate 110 with nodes B 104 and C 106, and nodes B 104 and C 106 can communicate 110 with each other. However, nodes A 102 and B 104 cannot communicate with node D 108. Because node D 108 can only communicate with node C 106, any communications 110 between node A 102 and node D 108, or between node B 104 and node D 108, must route through node C 106.

When requesting and distributing messages, the various exemplary devices illustrated in FIG. 1 and discussed above may communicate with one another via a mesh network 100. That is, the devices can transmit, receive, and relay messages between themselves as necessary.

For example, a method of drone-drone communications using blockchain may be implemented in the network 100. Such drone-to-drone communications may be used to clone drones. The method may include determining operational parameters of a first drone; encrypting the operational parameters of the first drone; storing the encrypted operational parameters of the first drone in a block of a blockchain; determining when a second drone is in proximity of the first drone; unencrypting the encrypted operational parameters of the first drone in the block of the blockchain; retrieving the operational parameters of the first drone from the block of the blockchain; and configuring the second drone with the operational parameters of the first drone. Encrypting the operational parameters of the first drone may include encrypting the operational parameters of the first drone by a unique identifier of the first drone. The operational parameters may comprise flight heights, flight speeds, flight routes, battery information, loading capacity, etc.

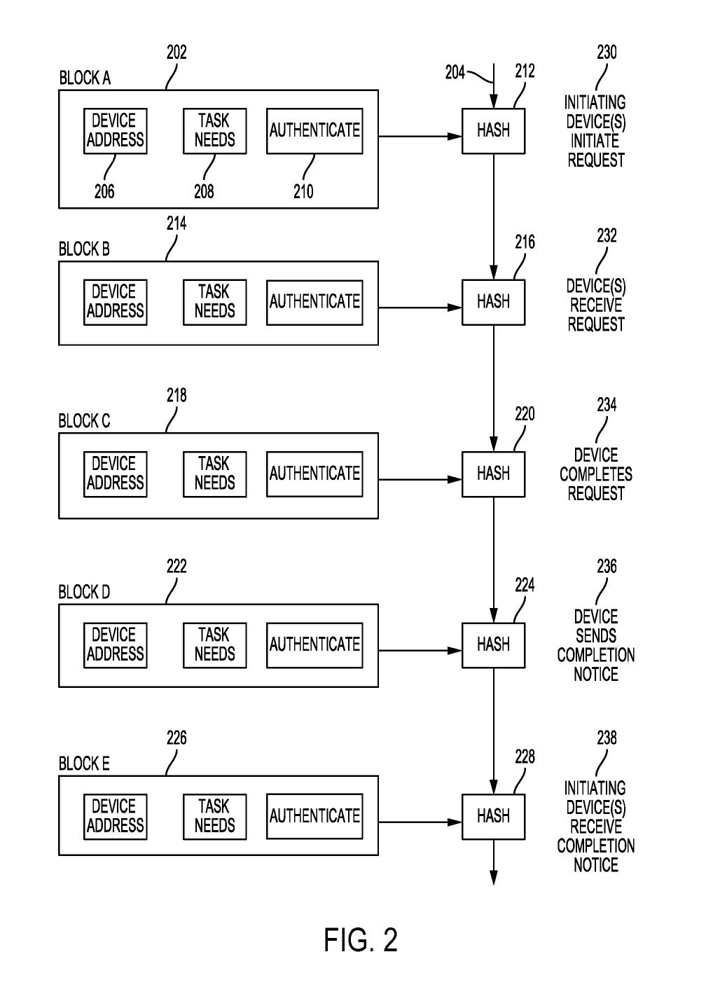

FIG. 2 illustrates an exemplary blockchain based on interactions between devices. A blockchain is a distributed digital ledger which is communicated electronically between devices. Each transaction recorded within the digital ledger is a block which can be hashed or otherwise encrypted. As new transactions are added to the digital ledger, each transaction's veracity can be tested against the previous ledger stored by the devices, and can, in some configurations, require confirmation from a defined percentage (usually 50%) of the devices to be added to the blockchain.

In the case of relaying message requests, and cloning operational parameters among the various devices based on the responses to the requests, the blockchain can take the form illustrated in FIG. 2. In this example, there is a blockchain 204 which has been distributed among multiple devices. One of the devices, an initiating device, determines that a message would be sent to a destination device, and proceeds to initiate a request 220. Initiation of the request, in this example, includes generating a block (Block A 202). In this example, each block added to the blockchain contains the device address 206 or identification of the device making the request, responding to the request, or otherwise communicating with the remaining devices in the group of devices. The block 202 can contain the task needs 208, which can include the specific request for resources or actions, responses to requests, completion notifications, etc. In addition, the block 202 can contain an authentication 210 portion, where the device can approve or authenticate the validity of other transactions and/or provide authority for the present transaction.

As the device generates the block 202 for the initial request, the block 202 is hashed 212 into the previous blockchain 204, resulting in an updated blockchain which is distributed among the devices in the group. The other devices receive the updated blockchain containing the request 232 and generate a block 214 in response to the request. These responses are hashed 216 into the blockchain. In some scenarios, an additional block could be generated by the initiating device based on the response block 214, indicating what action will be taken based on the responses received.

When a device completes the request 234, that device generates a block 218 which is subsequently hashed 220 and added to the blockchain. If a completion notice 236 needs to be generated and sent to the initiating device, the completing device can generate another block 222, which can similarly be hashed 224 and added to the blockchain. Once the initiating device receives the completion notice 238, it may generate a notification indicating the request has been fulfilled, which would similarly require a block 226 to be generated and hashed 228 into the blockchain.

An example system of drone-drone communications may be based on the above blockchain. For example, the system may comprise a plurality of drones configured to: receive an encrypted message by an initial drone of the plurality of drones, wherein the encrypted message is addressed to a destination drone of the plurality of drones and encrypted by an unique identifier of the destination drone; store the encrypted message in a first block of a blockchain; update the received encrypted message to include an unique identifier of the initial drone; store the updated message in a second block of the blockchain; relay the updated message to one or more intermediary drones of the plurality of drones, wherein the one or more intermediary drones are located between the initial drone and the destination drone, the one or more intermediary drones further update the updated message to include their corresponding unique identifiers, the further updated message is stored in a corresponding block of the block chain, the one or more intermediary drones relay the further updated message to the destination drone; and retrieve, by the destination drone, the encrypted message from the further updated message. The encrypted message may be received from a central controller.

The initial drone may be in a communication range of the central controller and the destination drone may not in the communication range of the central controller.

The plurality of drones may further be configured to update the received encrypted message to include a location of the initial drone, a serial number of the initial drone, a date on which the encrypted message is received by the initial drone, and/or a time at which the encrypted message is received by the initial drone. The updated message may be unencrypted or encrypted. The destination drone may further be configured to unlock the encrypted message with a private key.

The system may be further configured to alter a path or a speed of the one or more intermediary drones to relay the updated message. The system may be further configured to relay the updated message by the one or more intermediary drones based on a signal strength, a message priority, or availability of drones. The system may be further configured to audit communications between drones based on the blockchain. As used herein, the “audit” may refer to verify whether the communications are authentic communications, whether the communications come from designated drones, whether the communications are received by specified drones. The audit may be based on identifications of drones, hashed information in blocks of the blockchain, or user inputs.

The system may be further configured to identify a third-party drone for relaying the updated message and the further updated message. The third-party drone may be controlled by another entity, and not be included in the plurality of drones. The system may be further configured to stop a drone from relaying a message if the message is determined to redundant. For example, the redundancy of the message may be determined by referring to previous blocks of the blockchain. The plurality of drones may be further configured to act as a cell communication tower using blockchain for encryption and verification. The system may be further configured to perform as a wireless data provider on a limited basis for providing unused drone communications capacity. The system may be further configured to employ local WIFI signals to relay messages.

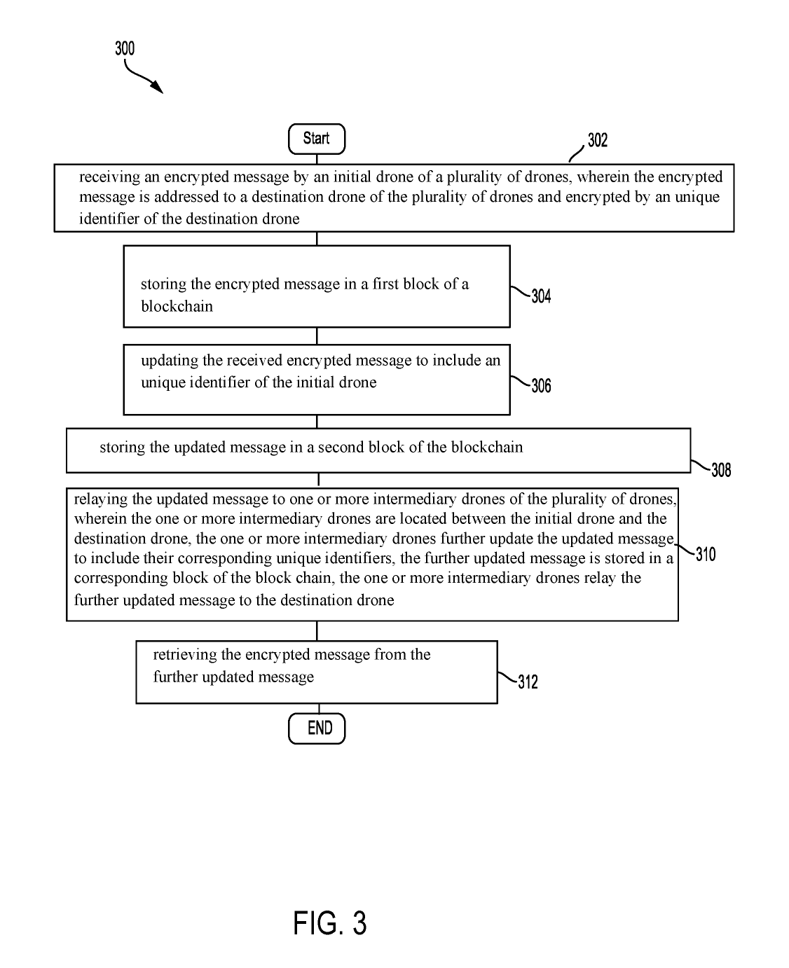

FIG. 3 illustrates an exemplary method 300 of communications between drones. This exemplary method can be performed, for example, by any drone within a group of drones, and can be used to distribute resources (e.g., information), share resources, transition actions, or otherwise between drones in a group.

At step 302, an encrypted message is received by an initial drone of a plurality of drones, wherein the encrypted message is addressed to a destination drone of the plurality of drones and encrypted by a unique identifier of the destination drone. The encrypted message may comprise operational parameters of the initial drone. In some embodiments, the message may not be encrypted, but may contain the unique identifier of the destination drone. The operational parameters may comprise flight heights, flight speeds, and flight routes of the initial drone.

At step 304, the encrypted message is stored in a first block of a blockchain. The encrypted message may be hashed into the first block. The updated blockchain with the first block may be distributed to the plurality of drones, such that each of the plurality of drones may have a copy of the updated blockchain.

At step 306, the received encrypted message may be updated to include a unique identifier of the initial drone to generate an updated message. The updated message including the encrypted message and the unique identifier of the initial drone may be an encrypted message or a message without encryption.

At step 308, the updated message may be stored in a second block of the blockchain. The updated message may be hashed into the second block of the blockchain. The updated blockchain with the second block may be distributed to the plurality of drones, such that each of the plurality of drones may have a copy of the updated blockchain with the second block.

At step 310, the updated message is relayed to one or more intermediary drones of the plurality of drones. The one or more intermediary drones are located between the initial drone and the destination drone. The one or more intermediary drones may further update the updated message to include their corresponding unique identifiers. The further updated message may be an encrypted message or a message without encryption. The further updated message is stored in a corresponding block of the block chain. The one or more intermediary drones may relay the further updated message to the destination drone.

At step 312, the encrypted message is retrieved from the further updated message. The further updated message may be received by the destination drone. The destination drone may be configured to retrieve the encrypted message from the further updated message. For example, the destination drone may retrieve the encrypted message by determining the identifiers of the initial and the intermediary drones. Further, the destination drone may be configured to unencrypt the encrypted message to obtain the operational parameters of the initial drone. The operational parameters of the initial drone may be used to configure the destination drone, such that the destination drone may operate and behave as the initial drone does. That is, the destination drone may be cloned by the initial drone.

In some embodiments, a method may comprise determining operational parameters of a first drone; encrypting the operational parameters of the first drone; storing the encrypted operational parameters of the first drone in a block of a blockchain; determining when a second drone is in proximity of the first drone; unencrypting the encrypted operational parameters of the first drone; retrieving the operational parameters of the first drone from the block of the blockchain; and configuring the second drone with the operational parameters of the first drone.

It is noted that components, elements, features, and/or limitations of this method can be combined as needed for specific configurations. For example, another exemplary method using this disclosure may be: identifying, at a first device in a plurality of devices, a need for additional computing capacity; transmitting a request for the additional computing capacity to one or more member devices in the plurality of devices, wherein the request indicates a planned computing state required to achieve the additional computing capacity; receiving, from at least one member device in the plurality of devices, at least one response to the request, wherein the at least one response contains a binary competence of the at least one member device to provide the additional computing capacity; and initiating, based on the binary competence, the planned computing state based on the at least one response to the request.

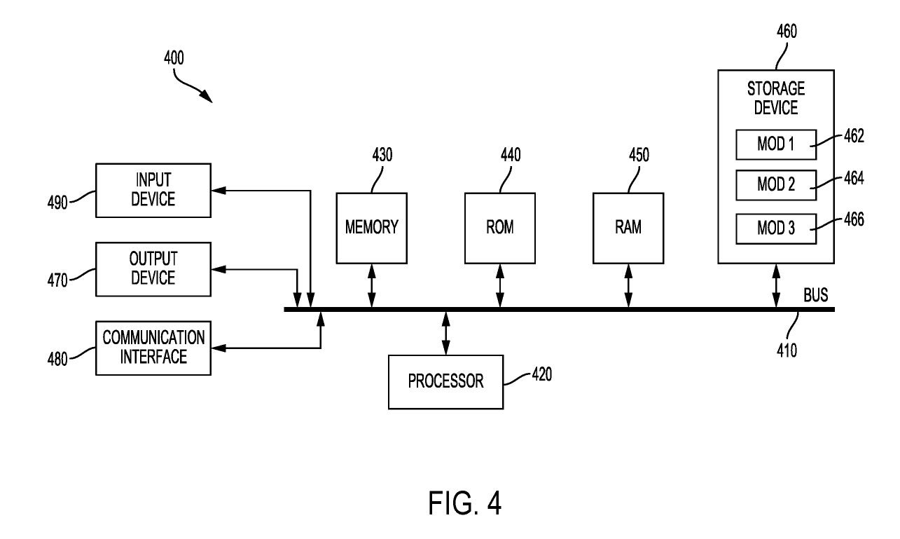

With reference to FIG. 4, an exemplary system 400 can include a processing unit (CPU or processor) 420 and a system bus 410 that couples various system components including the system memory 430 such as read only memory (ROM) 440 and random access memory (RAM) 450 to the processor 420. The system 400 can include a cache of high speed memory connected directly with, in close proximity to, or integrated as part of the processor 420. The system 400 copies data from the memory 430 and/or the storage device 460 to the cache for quick access by the processor 420. In this way, the cache provides a performance boost that avoids processor 420 delays while waiting for data. These and other modules can control or be configured to control the processor 420 to perform various actions. Other system memory 430 may be available for use as well. The memory 430 can include multiple different types of memory with different performance characteristics. It can be appreciated that the disclosure may operate on a computing device 400 with more than one processor 420 or on a group or cluster of computing devices networked together to provide greater processing capability. The processor 420 can include any general purpose processor and a hardware module or software module, such as module 1 462, module 2 464, and module 3 466 stored in storage device 460, configured to control the processor 420 as well as a special-purpose processor where software instructions are incorporated into the actual processor design. The processor 420 may essentially be a completely self-contained computing system, containing multiple cores or processors, a bus, memory controller, cache, etc. A multi-core processor may be symmetric or asymmetric.

The system bus 410 may be any of several types of bus structures including a memory bus or memory controller, a peripheral bus, and a local bus using any of a variety of bus architectures. A basic input/output (BIOS) stored in ROM 440 or the like, may provide the basic routine that helps to transfer information between elements within the computing device 400, such as during start-up. The computing device 400 further includes storage devices 460 such as a hard disk drive, a magnetic disk drive, an optical disk drive, tape drive or the like. The storage device 460 can include software modules 462, 464, 466 for controlling the processor 420. Other hardware or software modules are contemplated. The storage device 460 is connected to the system bus 410 by a drive interface. The drives and the associated computer-readable storage media provide nonvolatile storage of computer-readable instructions, data structures, program modules and other data for the computing device 400. In one aspect, a hardware module that performs a particular function includes the software component stored in a tangible computer-readable storage medium in connection with the necessary hardware components, such as the processor 420, bus 410, display 470, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 400 is a small, handheld computing device, a desktop computer, or a computer server.

Although the exemplary embodiment described herein employs the hard disk 460, other types of computer-readable media which can store data that are accessible by a computer, such as magnetic cassettes, flash memory cards, digital versatile disks, cartridges, random access memories (RAMs) 450, and read only memory (ROM) 440, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 400, an input device 490 represents any number of input mechanisms, such as a microphone for speech, a touch-sensitive screen for gesture or graphical input, keyboard, mouse, motion input, speech and so forth. An output device 440 can also be one or more of a number of output mechanisms known to those of skill in the art. In some instances, multimodal systems enable a user to provide multiple types of input to communicate with the computing device 400. The communications interface 480 generally governs and manages the user input and system output. There is no restriction on operating on any particular hardware arrangement and therefore the basic features here may easily be substituted for improved hardware or firmware arrangements as they are developed.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

We claim:

1. A method of drone-drone communications using blockchain, comprising:
determining operational parameters of a first drone;
encrypting the operational parameters of the first drone;
storing the encrypted operational parameters of the first drone in a block of a blockchain;
determining when a second drone is in proximity of the first drone;
retrieving the encrypted operational parameters of the first drone from the block of the blockchain;
decrypting the encrypted operational parameters of the first drone;
retrieving the operational parameters of the first drone based on the decryption; and
configuring the second drone with the operational parameters of the first drone.

2. The method of claim 1, wherein the encrypting the operational parameters of the first drone includes encrypting the operational parameters of the first drone by a unique identifier of the first drone.

3. The method of claim 1, wherein the operational parameters comprises flight heights, flight speeds, and flight routes.

4. The method of claim 1, wherein the determining when a second drone is in proximity of the first drone comprises:
detecting by the first drone a communication signal emitted by the second drone; and
evaluating strength of the communication signal to determine the proximity of the second drone with respect to the first drone.

5. The method of claim 1, wherein the decrypting the encrypted operational parameters of the first drone comprises:
retrieving a private key of the first drone from the block of the blockchain; and
decrypting the encrypted operational parameters by using the private key.

6. A blockchain-based system of drone-drone communications, comprising a plurality of drones configured to:
receive an encrypted message by an initial drone of the plurality of drones, wherein the encrypted message is addressed to a destination drone of the plurality of drones and encrypted by an unique identifier of the destination drone;
store the encrypted message in a first block of a blockchain;
update the received encrypted message to include an unique identifier of the initial drone;
store the updated message in a second block of the blockchain;
relay the updated message to one or more intermediary drones of the plurality of drones, wherein the one or more intermediary drones are located between the initial drone and the destination drone, the one or more intermediary drones further update the updated message to include their corresponding unique identifiers, the further updated message is stored in a corresponding block of the block chain, the one or more intermediary drones relay the further updated message to the destination drone; and
retrieve, by the destination drone, the encrypted message from the further updated message.

7. The system of claim 6, wherein the encrypted message is received from a central controller.

8. The system of claim 7, wherein the initial drone is in a communication range of the central controller and the destination drone is not in the communication range of the central controller.

9. The system of claim 6, wherein the plurality of drones are further configured to update the received encrypted message to include a location of the initial drone, a serial number of the initial drone, a date on which the encrypted message is received by the initial drone, and/or a time at which the encrypted message is received by the initial drone.

10. The system of claim 6, where the updated message is unencrypted.

11. The system of claim 6, wherein the updated message is encrypted.

12. The system of claim 6, wherein the destination drone is further configured to unlock the encrypted message with a private key.

13. The system of claim 6, wherein the system is further configured to alter a path and/or a speed of the one or more intermediary drones to relay the updated message.

14. The system of claim 6, wherein the system is further configured to relay the updated message by the one or more intermediary drones based on a signal strength, a message priority, and/or availability of drones.

15. The system of claim 6, wherein the system is further configured to audit communications between drones based on the blockchain.

16. The system of claim 6, wherein the system is further configure to identify a third-party drone for relaying the updated message and/or the further updated message, wherein the third-party drone is not included in the plurality of drones.

17. The system of claim 4, wherein the system is further configured to perform as a wireless data provider on a limited basis for providing unused drone communications capacity.

18. The system of claim 4, wherein the system is further configured to employ local WIFI signals to relay messages.

19. A blockchain-based method for drone-drone communications, comprising:
receiving an encrypted message by an initial drone of a plurality of drones, wherein the encrypted message is addressed to a destination drone of the plurality of drones and encrypted by an unique identifier of the destination drone;
storing the encrypted message in a first block of a blockchain;
updating the received encrypted message to include an unique identifier of the initial drone;
storing the updated message in a second block of the blockchain;
relaying the updated message to one or more intermediary drones of the plurality of drones, wherein the one or more intermediary drones are located between the initial drone and the destination drone, the one or more intermediary drones further update the updated message to include their corresponding unique identifiers, the further updated message is stored in a corresponding block of the block chain, the one or more intermediary drones relay the further updated message to the destination drone; and
retrieving the encrypted message from the further updated message.

20. The method of claim 19, wherein the encrypted message is received from a central controller.
